(19) United States
(12) Patent Application Publication
(10) Pub. No.: US 2016/0085389 A1
(43) Pub. Date: Mar. 24, 2016

(54) KNOWLEDGE AUTOMATION SYSTEM THUMBNAIL IMAGE GENERATION

(71) Applicant: Kaybus, Inc., San Francisco, CA (US)

(72) Inventors: Gazi Mahmud, Berkeley, CA (US); Ravindra Guntur, Mysore (IN); Sumukh Rama Avadhani, Bangalore (IN); Tao Liang, San Francisco, CA (US); Deanna Liang, San Francisco, CA (US)

(21) Appl. No.: 14/862,957

(22) Filed: Sep. 23, 2015

Related U.S. Application Data
(60) Provisional application No. 62/054,333, filed on Sep. 23, 2014.

(51) Int. Cl. G06F 3/0482; G06F 3/0484; G06F 3/0481

(52) U.S. Cl. CPC G06F 3/0482; G06F 3/04817; G06F 3/04842

(57) ABSTRACT

Knowledge automation techniques may include receiving a request for determining a representative image for a knowledge unit and determining a set of one or more images associated with the knowledge unit. The techniques may include providing the set of one or more images to a user on a client device and receiving user input indicative of a selection of a first image from the set of one or more images. Based on the first image, a thumbnail image for the knowledge unit can be generated. The techniques may further include associating the thumbnail image with the knowledge unit and displaying the thumbnail image to the user via the client device. In some embodiments, the techniques include generating a thumbnail image for a knowledge pack, wherein the knowledge pack comprises one or more knowledge units.

### CROSS-REFERENCES TO RELATED APPLICATIONS

The present application is a non-provisional of and claims the benefit and priority of U.S. Provisional Application No. 62/054,333, filed Sep. 23, 2014, entitled “Automatic Thumbnail Generation,” the entire contents of all of which are incorporated herein by reference for all purposes.

### BACKGROUND OF THE INVENTION

The present disclosure generally relates to knowledge automation. More particularly, techniques are disclosed for transforming data content into knowledge suitable for consumption by users.

With the vast amount of data content available, users often suffer from information overload. For example, in an enterprise environment, a large corporation may store all the data that users need to complete their tasks. However, finding the right data for the right user can be challenging. Users may often spend substantial amount of time looking for a needle in a haystack in trying to find the right data to fill their particular needs from thousands of data files. In a collaborative environment, even after the right data is found, substantial amount of time may be needed to synthesis that data into a suitable output that can be consumed by others. The amount of time that users spend searching and synthesizing the data may also create excessive load on the enterprise computing systems and slow down the processing of other tasks.

Data content can be represented and described using a number of different keys, such as a title of a document, published date, summary of the document, tags etc. However, finding an accurate representation of the data content within a document that provides useful information to a user about the content of the document can oftentimes be challenging.

Embodiments of the present invention address these and other problems individually and collectively.

### BRIEF SUMMARY OF THE INVENTION

The present disclosure generally relates to knowledge automation. More particularly, knowledge automation techniques are disclosed for transforming data content within documents into knowledge units and knowledge packs suitable for consumption by users. In an embodiment, the knowledge automation techniques include generating a thumbnail image for a knowledge unit and/or a knowledge pack.

In certain embodiments, techniques are provided (e.g., a method, a system, non-transitory computer-readable medium storing code or instructions executable by one or more processors) for generating thumbnail images for knowledge units and knowledge packs. In an embodiment, a method for generating a thumbnail image for a knowledge unit is disclosed. The method may include receiving, by a data processing system, a request for determining a representative image for a knowledge unit. The method may include determining a set of one or more images associated with the knowledge unit by analyzing text and non-text regions in the knowledge unit. In some embodiments, the method may include providing the set of one or more images to a user on a client device and receiving user input indicative of a selection of a first image (e.g., a representative image) from the set of one or more images. The set of one or more images may include visual representations of the data contents within the knowledge unit. The method may then include generating a thumbnail image for the knowledge unit based on the first image. In some examples, the “thumbnail image” may be a reduced size version of the representative image of the knowledge unit and/or knowledge pack. The method may then include associating the thumbnail image with the knowledge unit and displaying the thumbnail image to the user via the client device. In some examples, the method may include displaying the knowledge unit to the user on the client device when the thumbnail is displayed to the user.

In some embodiments, the method may include receiving a selection of multiple (i.e., more than one) images from the set of one or more images from the user. The method may include combining the selected one or more images into a single representative image for the knowledge pack. For instance, the method may include merging the selected one or more images onto a collage or animated image to generate a representative image for the knowledge unit. The method may then include generating a thumbnail image for the knowledge unit based on the representative image and associating the thumbnail image with the knowledge unit. In some embodiments, the method may then include displaying the thumbnail image to the user via the client device.

In some embodiments, the method may include automatically determining a representative image for a knowledge unit. In this embodiment, the method may include identifying a plurality of features corresponding to the set of one or more images and assigning a plurality of weights to the plurality of features. The method may further include determining a score for each image in the set of one or more images based on the plurality of weights and identifying an image in the set of one or more images with the highest score. The method may then include identifying an image in the set of one or more images with the highest score and determining the identified image as the representative image for the knowledge unit. In some embodiments, the method may then include generating the thumbnail image for the knowledge unit based at least in part on the representative image.

In some embodiments, the method may include generating a thumbnail image for a knowledge unit that does not contain any extractable images. In this embodiment, the method may include determining a set of tags associated with the knowledge unit. In some examples, the set of tags identify one or more terms that describe data content within the knowledge unit. The method may then include generating the thumbnail image for the knowledge unit based at least in part on the set of tags. For instance, in some embodiments, the method may include identifying a stored set of one or more images and comparing the set of tags associated with the knowledge unit to one or more sets of tags associated with the stored set of one or more images. The method may then include determining one or more matching sets of tags based on the comparing and determining a best match set of tags from the one or more matching sets of tags. In some examples, the method may further include identifying an image from the stored set of one or more images that corresponds to the best match set of tags, determining the identified image as the representative image for the knowledge unit and generating the thumbnail image for the knowledge unit based at least in part on the representative image.

In some embodiments, the method may include identifying multiple sets of tags (instead of a single best match set of tags) from the one or more matching sets of tags. In this embodiment, the method may include identifying images from the stored set of one or more images that correspond to each set of tags in the multiple sets of tags and providing the identified images to a user on the client device. The method may further include receiving user input indicative of a user-selected image from the identified images and identifying the user-selected image as the representative image for the knowledge unit. The method may then include generating the thumbnail image for the knowledge unit based at least in part on the representative image.

In certain embodiments, a non-transitory computer-readable storage memory storing a plurality of instructions executable by one or more processors is disclosed. The instructions include instructions that cause the one or more processors to receive a request for determining a representative image for a knowledge unit, determine a set of one or more images associated with the knowledge unit and provide the set of one or more images to a user on a client device. The instructions further include instructions that cause the one or more processors to receive user input indicative of a selection of a first image from the set of one or more images and generate a thumbnail image for the knowledge unit based at least in part on the first image. In some embodiments, the instructions further include instructions that cause the one or more processors to associate the thumbnail image with the knowledge unit and display the thumbnail image to the user via the client device.

In accordance with certain embodiments, a system for generating a thumbnail image for a knowledge pack is provided. The system includes one or more processors and a memory coupled with and readable by the one or more processors. The memory is configured to store a set of instructions which, when executed by the one or more processors, causes the one or more processors to receive a request for determining a representative image for a knowledge pack, determine a set of tags associated with the knowledge pack, determine a set of one or more images for the knowledge pack based at least in part on the tags, determine a representative image for the knowledge pack based on the set of one or more images, generate a thumbnail image for the knowledge pack based on the representative image, associate the thumbnail image with the knowledge pack and display the thumbnail image for the knowledge pack to a user via a client device.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 illustrates an environment in which a knowledge automation system can be implemented, according to some embodiments.

FIG. 2 illustrates a flow diagram depicting some of the processing that can be performed by a knowledge automation system, according to some embodiments.

FIG. 3 illustrates a block diagram of a knowledge automation system, according to some embodiments.

FIG. 4 illustrates a multi-tenant environment 400 in which a knowledge automation system 402 can be implemented, according to some embodiments.

FIG. 5 illustrates a high level flow diagram of an example process 500 for generating thumbnail images for a knowledge unit, in accordance with an embodiment of the present invention.

FIG. 6A illustrates a flow diagram of an example process 600 for generating a thumbnail image for a knowledge unit, in accordance with another embodiment of the present invention.

FIG. 6B illustrates a flow diagram of an example process 608 for generating a thumbnail image for a knowledge unit when the knowledge unit contains at least one extractable image.

FIG. 6C illustrates a flow diagram of an example process 618 for generating a thumbnail image for a knowledge unit when the knowledge unit contains multiple extractable images.

FIG. 6D illustrates a flow diagram of an example process 634 for generating a thumbnail image for a knowledge unit when the knowledge unit does not contain any extractable images.

FIG. 7 illustrates a high level flow diagram of an example process 700 for generating a thumbnail image for a knowledge pack, in accordance with an embodiment of the present invention.

FIG. 8 illustrates a high level flow diagram of an example process 800 for generating a thumbnail image for a knowledge pack (KP) in accordance with another embodiment of the present invention.

FIG. 9 illustrates a graphical user interface 900 for displaying representative images and thumbnail images for a knowledge unit and/or a knowledge pack, according to some embodiments.

FIG. 10 depicts a block diagram of a computing system 1000, in accordance with some embodiments.

FIG. 11 depicts a simplified block diagram of a service provider system 1100, in accordance with some embodiments.

### DETAILED DESCRIPTION OF THE INVENTION

The present disclosure relates generally to knowledge automation. Certain techniques are disclosed for discovering data content and transforming information in the data content into knowledge units. Techniques are also disclosed for composing individual knowledge units into knowledge packs, and mapping the knowledge to the appropriate target audience for consumption. Techniques are further disclosed for generating thumbnail images for knowledge units and knowledge packs.

Substantial amounts of data (e.g., data files such as documents, emails, images, code, and other content, etc.) may be available to users in an enterprise. These users may rely on information contained in the data to assist them in performing their tasks. The users may also rely on information contained in the data to generate useful knowledge that is consumed by other users. For example, a team of users may take technical specifications related to a new product release, and generate a set of training materials for the technicians who will install the new product. However, the large quantities of data available to these users may make it difficult to identify the right information to use.

Machine learning techniques can analyze content at scale (e.g., enterprise-wide and beyond) and identify patterns of what is most useful to which users. Machine learning can be used to model both the content accessible by an enterprise system (e.g., local storage, remote storage, and cloud storage services, such as SharePoint, Google Drive, Box, etc.), and the users who request, view, and otherwise interact with the content. Based on a user's profile and how the user interacts with the available content, each user's interests, expertise, and peers can be modeled. The data content can then be matched to the appropriate users who would most likely be interested in that content. In this manner, the right knowledge can be provided to the right users at the right time. This not only improves the efficiency of the users in identifying and consuming knowledge relevant for each user, but also improves the efficiency of computing systems by freeing up computing resources that would otherwise be consumed by efforts to search and locate the right knowledge, and allowing these computing resources to be allocated for other tasks.

To make effective use of the content available to the user, knowledge units and/or knowledge packs can be presented to the user through a graphical user interface. In addition to information about the content (such as title, publication information, authorship information, etc.) in some embodiments, a thumbnail image can be displayed. For image and/or video-based content, thumbnail images can be generated by conventional means. However, for text-based content (research papers, white papers, instruction manuals, and other documents), thumbnail images are typically generated based on a first page of the content. This often results in a thumbnail image that provides very little information to the user about the content of the knowledge unit and/or knowledge pack.

Embodiments of the present invention present techniques for generating representative images for non-multimedia documents such as text documents, PDF documents, and the like by analyzing the data contents of a knowledge unit and/or knowledge pack. Multiple representative images for a knowledge unit and/or knowledge pack can be generated and merged to form a single representative image (e.g., a collage or animated image) for the knowledge unit and/or knowledge pack. A thumbnail image may then be generated for the knowledge unit and/or knowledge pack based on the representative image. In some examples, the thumbnail image may be a reduced sized image version of the representative image of the knowledge unit and/or knowledge pack. In some embodiments, a user can manually select one or more representative images for a knowledge unit and/or knowledge pack. In other embodiments, a representative image for a knowledge unit and/or knowledge pack can be automatically generated by a knowledge automation system and/or identified from external image sources and presented to a user on the user's client device. In some embodiments, dynamic metadata can be integrated into a representative image for a knowledge unit and/or knowledge pack.

### I. Architecture Overview

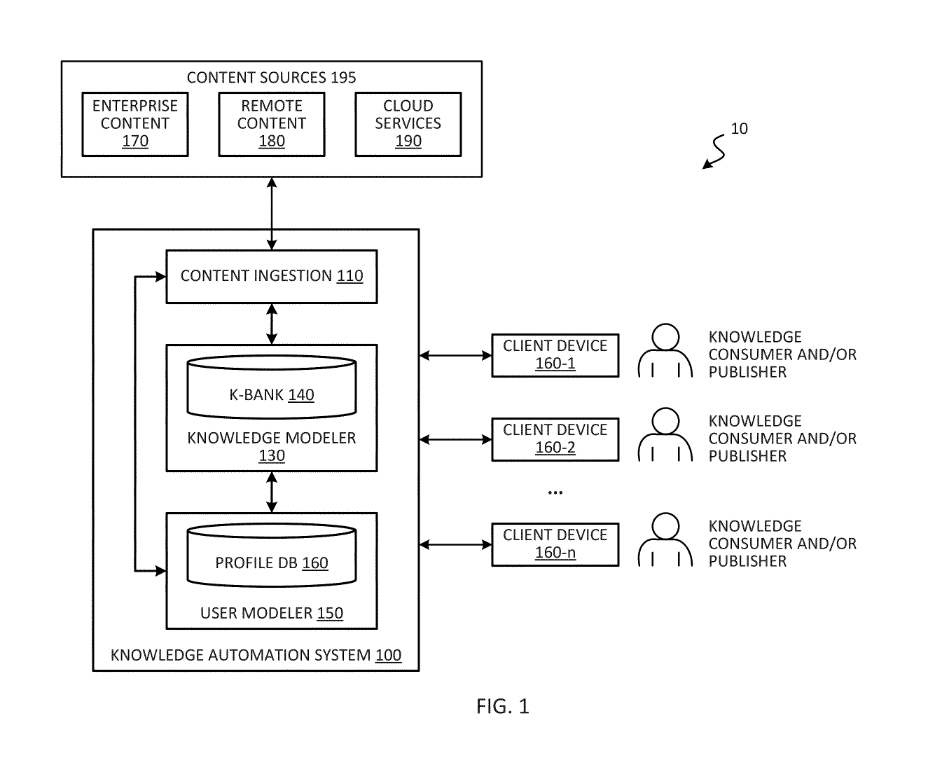

FIG. 1 illustrates an environment 10 in which a knowledge automation system 100 can be implemented, according to some embodiments. As shown in FIG. 1, a number of client devices 160-1, 160-2, . . . 160-n can be used by a number of users to access services provided by knowledge automation system 100. The client devices may be of various different types, including, but not limited to personal computers, desktops, mobile or handheld devices such as laptops, smart phones, tablets, etc., and other types of devices. Each of the users can be a knowledge consumer who accesses knowledge from knowledge automation system 100, or a knowledge publisher who publishes or generates knowledge in knowledge automation system 100 for consumption by other users. In some embodiments, a user can be both a knowledge consumer or a knowledge publisher, and a knowledge consumer or a knowledge publisher may refer to a single user or a user group that includes multiple users.

Knowledge automation system 100 can be implemented as a data processing system, and may discover and analyze content from one or more content sources 195 stored in one or more data repositories, such as a databases, file systems, management systems, email servers, object stores, and/or other repositories or data stores. In some embodiments, client devices 160-1, 160-2, . . . 160-n can access the services provided by knowledge automation system 100 through a network such as the Internet, a wide area network (WAN), a local area network (LAN), an Ethernet network, a public or private network, a wired network, a wireless network, or a combination thereof. Content sources 195 may include enterprise content 170 maintained by an enterprise, remote content 180 maintained at one or more remote locations (e.g., the Internet), cloud services content 190 maintained by cloud storage service providers, etc. Content sources 195 can be accessible to knowledge automation system 100 through a local interface, or through a network interface connecting knowledge automation system 100 to the content sources via one or more of the networks described above. In some embodiments, one or more of the content sources 195, one or more of the client devices 160-1, 160-2, . . . 160-n, and knowledge automation system 100 can be part of the same network, or can be part of different networks.

Each client device can request and receive knowledge automation services from knowledge automation system 100. Knowledge automation system 100 may include various software applications that provide knowledge-based services to the client devices. In some embodiments, the client devices can access knowledge automation system 100 through a thin client or web browser executing on each client device. Such software as a service (SaaS) models allow multiple different clients (e.g., clients corresponding to different customer entities) to receive services provided by the software applications without installing, hosting, and maintaining the software themselves on the client device.

Knowledge automation system 100 may include a content ingestion module 110, a knowledge modeler 130, and a user modeler 150, which collectively may extract information from data content accessible from content sources 195, derive knowledge from the extracted information, and provide recommendation of particular knowledge to particular clients. Knowledge automation system 100 can provide a number of knowledge services based on the ingested content. For example, a corporate dictionary can automatically be generated, maintained, and shared among users in the enterprise. A user's interest patterns (e.g., the content the user typically views) can be identified and used to provide personalized search results to the user. In some embodiments, user requests can be monitored to detect missing content, and knowledge automation system 100 may perform knowledge brokering to fill these knowledge gaps. In some embodiments, users can define knowledge campaigns to generate and distribute content to users in an enterprise, monitor the usefulness of the content to the users, and make changes to the content to improve its usefulness.

Content ingestion module 110 can identify and analyze enterprise content 170 (e.g., files and documents, other data such as e-mails, web pages, enterprise records, code, etc. maintained by the enterprise), remote content 180 (e.g., files, documents, and other data, etc. stored in remote databases), cloud services content 190 (e.g., files, documents, and other data, etc. accessible form the cloud), and/or content from other sources. For example, content ingestion module 110 may crawl or mine one or more of the content sources to identify the content stored therein, and/or monitor the content sources to identify content as they are being modified or added to the content sources. Content ingestion module 110 may parse and synthesize the content to identify the information contained in the content and the relationships of such information. In some embodiments, ingestion can include normalizing the content into a common format, and storing the content as one or more knowledge units in a knowledge bank 140 (e.g., a knowledge data store). In some embodiments, content can be divided into one or more portions during ingestion. For example, a new product manual may describe a number of new features associated with a new product launch. During ingestion, those portions of the product manual directed to the new features may be extracted from the manual and stored as separate knowledge units. These knowledge units can be tagged or otherwise be associated with metadata that can be used to indicate that these knowledge units are related to the new product features. In some embodiments, content ingestion module 110 may also perform access control mapping to restrict certain users from being able to access certain knowledge units.

Knowledge modeler 130 may analyze the knowledge units generated by content ingestion module 120, and combine or group knowledge units together to form knowledge packs. A knowledge pack may include various related knowledge units (e.g., several knowledge units related to a new product launch can be combined into a new product knowledge pack). In some embodiments, a knowledge pack can be formed by combining other knowledge packs, or a mixture of knowledge unit(s) and knowledge pack(s). The knowledge packs can be stored in knowledge bank 140 together with the knowledge units, or be stored separately. Knowledge modeler 130 may automatically generate knowledge packs by analyzing the topics covered by each knowledge unit, and combining knowledge units covering a similar topic into a knowledge pack. In some embodiments, knowledge modeler 130 may allow a user (e.g., a knowledge publisher) to build custom knowledge packs, and to publish custom knowledge packs for consumption by other users.

User modeler 150 may monitor user activities on the system as they interact with the knowledge bank 140 and the knowledge units and knowledge packs stored therein (e.g., the user's search history, knowledge units and knowledge packs consumed, knowledge packs published, time spent viewing each knowledge pack and/or search results, etc.). User modeler 150 may maintain a profile database 160 that stores user profiles for users of knowledge automation system 100. User modeler 150 may augment the user profiles with behavioral information based on user activities. By analyzing the user profile information, user modeler 150 can match a particular user to knowledge packs that the user may be interested in, and provide the recommendations to that user. For example, if a user has a recent history of viewing knowledge packs directed to a wireless networks, user modeler module 150 may recommend other knowledge packs directed to wireless networks to the user. As the user interacts with the system, user modeler 150 can dynamically modify the recommendations based on the user's behavior. User modeler 150 may also analyze search results performed by users to determine the effectiveness of the search results successful (e.g., did the user select and use the results), and to identify potential knowledge gaps in the system. In some embodiments, user modeler 150 may provide these knowledge gaps to content ingestion module 310 to find useful content to fill the knowledge gaps.

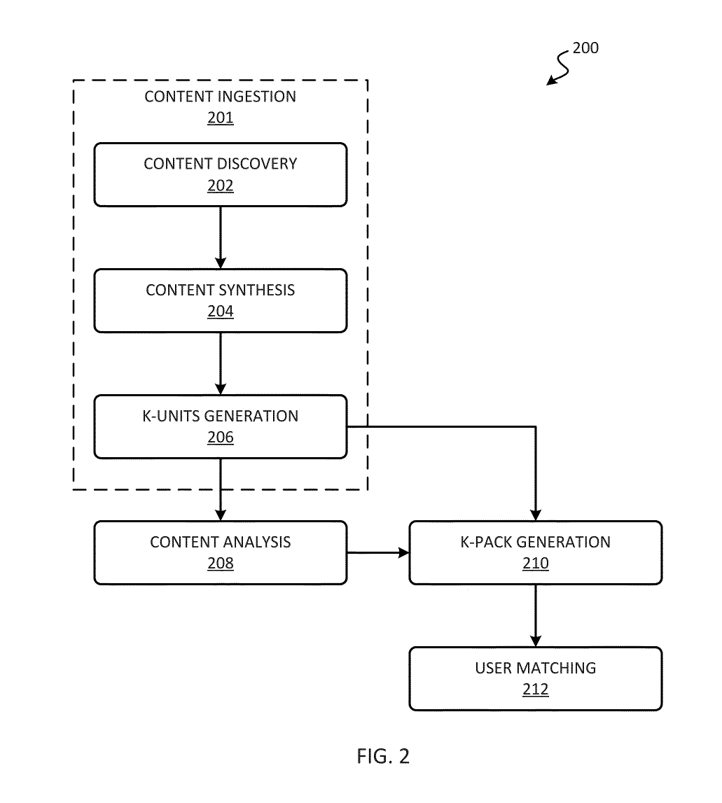

FIG. 2 illustrates a simplified flow diagram 200 depicting some of the processing that can be performed, for example, by a knowledge automation system, according to some embodiments. The processing depicted in FIG. 2 may be implemented in software (e.g., code, instructions, program) executed by one or more processing units (e.g., processors, cores), hardware, or combinations thereof. The software may be stored in memory (e.g., on a non-transitory computer-readable storage medium such as a memory device).

The processing illustrated in flow diagram 200 may begin with content ingestion 201. Content ingestion 201 may include content discovery 202, content synthesis 204, and knowledge units generation 206. Content ingestion 201 can be initiated at block 202 by performing content discovery to identify and discover data content (e.g., data files) at one or more data sources such as one or more data repositories. At block 204, content synthesis is performed on the discovered data content to identify information contained in the content. The content synthesis may analyze text, patterns, and metadata variables of the data content.

At block 206, knowledge units are generated from the data content based on the synthesized content. Each knowledge unit may represent a chunk of information that covers one or more related subjects. The knowledge units can be of varying sizes. For example, each knowledge unit may correspond to a portion of a data file (e.g., a section of a document) or to an entire data file (e.g., an entire document, an image, etc.). In some embodiments, multiple portions of data files or multiple data files can also be merged to generate a knowledge unit. By way of example, if an entire document is focused on a particular subject, a knowledge unit corresponding to the entire document can be generated. If different sections of a document are focused on different subjects, then different knowledge units can be generated from the different sections of the document. A single document may also result in both a knowledge unit generated for the entire document as well as knowledge units generated from portions of the document. As another example, various email threads relating to a common subject can be merged into a knowledge unit. The generated knowledge units are then indexed and stored in a searchable knowledge bank.

At block 208, content analysis is performed on the knowledge units. The content analysis may include performing semantics and linguistics analyses and/or contextual analysis on the knowledge units to infer concepts and topics covered by the knowledge units. Key terms (e.g., keywords and key phrases) can be extracted, and each knowledge unit can be associated with a term vector of key terms representing the content of the knowledge unit. In some embodiments, named entities can be identified from the extracted key terms. Examples of named entities may include place names, people's names, phone numbers, social security numbers, business names, dates and time values, etc. Knowledge units covering similar concepts can be clustered, categorized, and tagged as pertaining to a particular topic or topics. Taxonomy generation can also be performed to derive a corporate dictionary identifying key terms and how the key terms are used within an enterprise.

At block 210, knowledge packs are generated from individual knowledge units. The knowledge packs can be automatically generated by combining knowledge units based on similarity mapping of key terms, topics, concepts, metadata such as authors, etc. In some embodiments, a knowledge publisher can also access the knowledge units generated at block 206 to build custom knowledge packs. A knowledge map representing relationships between the knowledge packs can also be generated to provide a graphical representation of the knowledge corpus in an enterprise.

At block 212, the generated knowledge packs are mapped to knowledge consumers who are likely to be interested in the particular knowledge packs. This mapping can be performed based on information about the user (e.g., user's title, job function, etc.), as well as learned behavior of the user interacting with the system (e.g., knowledge packs that the user has viewed and consumed in the past, etc.). The user mapping can also take into account user feedback (e.g., adjusting relative interest levels, search queries, ratings, etc.) to tailor future results for the user. Knowledge packs mapped to a particular knowledge consumer can be distributed to the knowledge consumer by presenting the knowledge packs on a recommendations page for the knowledge consumer.

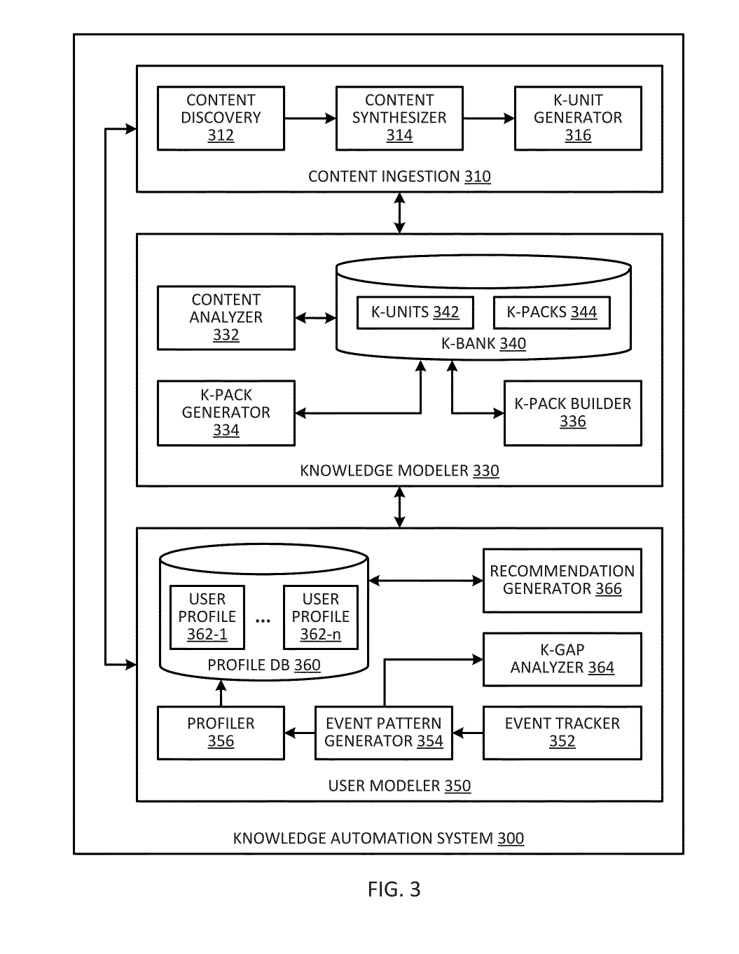

FIG. 3 illustrates a more detailed block diagram of a knowledge automation system 300, according to some embodiments. Knowledge automation system 300 can be implemented as a data processing system, and may include a content ingestion module 310, a knowledge modeler 330, and a user modeler 350. In some embodiments, the processes performed by knowledge automation system 300 can be performed in real-time. For example, as the data content or knowledge corpus available to the knowledge automation system changes, knowledge automation system 300 may react in real-time and adapt its services to reflect the modified knowledge corpus.

Content ingestion module 310 may include a content discovery module 312, a content synthesizer 314, and a knowledge unit generator 316. Content discovery module 312 interfaces with one or more content sources to discover contents stored at the content sources, and to retrieve the content for analysis. In some embodiments, knowledge automation system 300 can be deployed to an enterprise that already has a pre-existing content library. In such scenarios, content discovery module 312 can crawl or mine the content library for existing data files, and retrieve the data files for ingestion. In some embodiments, the content sources can be continuously monitored to detect the addition, removal, and/or updating of content. When new content is added to a content source or a pre-existing content is updated or modified, content discovery module 312 may retrieve the new or updated content for analysis. New content may result in new knowledge units being generated, and updated content may result in modifications being made to affected knowledge units and/or new knowledge units being generated. When content is removed from a content source, content discovery module 312 may identify the knowledge units that were derived from the removed content, and either remove the affected knowledge units from the knowledge bank, or tag the affected knowledge units as being potentially invalid or outdated.

Content synthesizer 314 receives content retrieved by content discovery module 312, and synthesizes the content to extract information contained in the content. The content retrieved by content discovery module 312 may include different types of content having different formats, storage requirements, etc. As such, content synthesizer 314 may convert the content into a common format for analysis. Content synthesizer 314 may identify key terms (e.g., keywords and/or key phrases) in the content, determine a frequency of occurrence of the key terms in the content, and determining locations of the key terms in the content. In addition to analyzing information contained in the content, content synthesizer 314 may also extract metadata associated with the content (e.g., author, creation date, title, revision history, etc.).

Knowledge unit generator 314 may then generate knowledge units from the content based on patterns of key terms used in the content and the metadata associated with the content. For example, if a document has a large frequency of occurrence of a key term in the first three paragraphs of the document, but a much lower frequency of occurrence of that same key term in the remaining portions of the document, the first three paragraphs of the document can be extracted and formed into a knowledge unit. As another example, if there is a large frequency of occurrence of a key term distributed throughout a document, the entire document can be formed into a knowledge unit. The generated knowledge units are stored in a knowledge bank 340, and indexed based on the identified key terms (also referred to herein as “tags”) and metadata to make the knowledge units searchable in knowledge bank 340.

Knowledge modeler 330 may include content analyzer 332, knowledge bank 340, knowledge pack generator 334, and knowledge pack builder 336. Content analyzer 332 may perform various types of analyses on the knowledge units to model the knowledge contained in the knowledge units. For example, content analyzer 332 may perform key term extraction and entity (e.g., names, companies, organizations, etc.) extraction on the knowledge units, and build a taxonomy of key terms and entities representing how the key terms and entities are used in the knowledge units. Content analyzer 332 may also perform contextual, sematic, and linguistic analyses on the knowledge units to infer concepts and topics covered by the knowledge units. For example, natural language processing can be performed on the knowledge units to derive concepts and topics covered by the knowledge units. Based on the various analyses, content analyzer 332 may derive a term vector for each knowledge unit to represent the knowledge contained in each knowledge unit. The term vector for a knowledge unit may include key terms, entities, and dates associated with the knowledge unit, topic and concepts associated with the knowledge unit, and/or other metadata such as authors associated with the knowledge unit. Using the term vectors, content analyzer 332 may perform similarity mapping between the knowledge units to identify knowledge units that cover similar topics or concepts.

Knowledge pack generator 334 may analyze the similarity mapping performed by content analyzer 332, and automatically form knowledge packs by combining similar knowledge units. For example, knowledge units that share at least five common key terms can be combined to form a knowledge pack. As another example, knowledge units covering the same topic can be combined to form a knowledge pack. In some embodiments, a knowledge pack may include other knowledge packs, or a combination of knowledge pack(s) and knowledge unit(s). For example, knowledge packs that are viewed and consumed by the a set of users can be combined into a knowledge pack. The generated knowledge packs can be tagged with their own term vectors to represent the knowledge contain in the knowledge pack, and be stored in knowledge bank 340.

Knowledge pack builder 336 may provide a user interface to allow knowledge publishers to create custom knowledge packs. Knowledge pack builder 336 may present a list of available knowledge units to a knowledge publisher to allow the knowledge publisher to select specific knowledge units to include in a knowledge pack. In this manner, a knowledge publisher can create a knowledge pack targeted to specific knowledge consumers. For example, a technical trainer can create a custom knowledge pack containing knowledge units covering specific new features of a produce to train a technical support staff. The custom knowledge packs can also be tagged and stored in knowledge bank 340.

Knowledge bank 340 is used for storing knowledge units 342 and knowledge packs 344. Knowledge bank 340 can be implemented as one or more data stores. Although knowledge bank 340 is shown as being local to knowledge automation system 300, in some embodiments, knowledge bank 340, or part of knowledge bank 340 can be remote to knowledge automation system 300. In some embodiments, frequently requested, or otherwise highly active or valuable knowledge units and/or knowledge packs, can be maintained in a low latency, multiple redundancy data store. This makes the knowledge units and/or knowledge packs quickly available when requested by a user. Infrequently accessed knowledge units and/or knowledge packs may be stored separately in slower storage.

Each knowledge unit and knowledge pack can be assigned an identifier that is used to identify and access the knowledge unit or knowledge pack. In some embodiments, to reduce memory usage, instead of storing the actual content of each knowledge unit in knowledge bank 340, the knowledge unit identifier referencing the knowledge unit and the location of the content source of the content associated with the knowledge unit can be stored. In this manner, when a knowledge unit is accessed, the content associated with the knowledge unit can be retrieved from the corresponding content source. For a knowledge pack, an knowledge pack identifier referencing the knowledge pack, and the identifiers and locations of the knowledge units and/or knowledge packs that make up the knowledge pack can be stored. Thus, a particular knowledge pack can be thought of as a container or a wrapper object for the knowledge units and/or knowledge packs that make up the particular knowledge pack. In some embodiments, knowledge bank 340 may also store the actual content of the knowledge units, for example, in a common data format. In some embodiments, knowledge bank 340 may selectively store some content while not storing other content (e.g., content of new or frequently accessed knowledge units can be stored, whereas stale or less frequently accessed content are not stored in knowledge bank 340).

Knowledge units 342 can be indexed in knowledge bank 340 according to key terms contained in the knowledge unit (e.g., may include key words, key phrases, entities, dates, etc. and number of occurrences of such in the knowledge unit) and/or associated metadata (e.g., author, location such as URL or identifier of the content, date, language, subject, title, file or document type, etc.). In some embodiments, the metadata associated with a knowledge unit may also include metadata derived by knowledge automation system 300. For example, this may include information such as access control information (e.g., which user or user group can view the knowledge unit), topics and concepts covered by the knowledge unit, knowledge consumers who have viewed and consumed the knowledge unit, knowledge packs that the knowledge unit is part of, time and frequency of access, etc.). Knowledge packs 344 stored in knowledge bank may include knowledge packs automatically generated by the system, and/or custom knowledge packs created by users (e.g., knowledge publishers). Knowledge packs 344 may also be indexed in a similar manner as for knowledge packs described above. In some embodiments, the metadata for a knowledge pack may include additional information that a knowledge unit may not have. For example, these may include a category type (e.g., newsletter, emailer, training material, etc.), editors, target audience, etc.

In some embodiments, a term vector can be associated with each knowledge element (e.g., a knowledge unit and/or a knowledge pack). The term vector may include key terms, metadata, and derived metadata associated with the each knowledge element. In some embodiments, instead of including all key terms present in a knowledge element, the term vector may include a predetermined number of key terms with the highest occurrence count in the knowledge element (e.g., the top five key terms in the knowledge element, etc.), or key terms that have greater than a minimum number of occurrences (e.g., key terms that appear more than ten times in a knowledge element, etc.).

User modeler 350 may include an event tracker 352, an event pattern generator 354, a profiler 356, a knowledge gap analyzer 364, a recommendations generator 366, and a profile database 360 that stores a user profile for each user of knowledge automation system 300. Event tracker 352 monitors user activities and interactions with knowledge automation system 300. For example, the user activities and interactions may include knowledge consumption information such as which knowledge unit or knowledge pack that a user has viewed, the length of time spent on the knowledge unit/pack, and when did the user access the knowledge unit/pack. The user activities and interactions tracked by event tracker 352 may also include search queries performed by the users, and user responses to the search results (e.g., number and frequency of similar searches performed by the same user and by other users, amount of time a user spends on reviewing the search result, how deep into a result list the user traversed, the number of items in the result list the user accessed and length of time spend on each item, etc.). If a user is a knowledge publisher, event tracker 352 may also track the frequency that the knowledge publisher publishes, when the knowledge publisher publishes, and topics or categories that the knowledge publisher publishes in, etc.

Event pattern generator 354 may analyze the user activities and interactions tracked by event tracker 352, and derive usage or event patterns for users or user groups. Profiler 356 may analyze these patterns and augment the user profiles stored in profile database 360. For example, if a user has a recent history of accessing a large number of knowledge packs relating to a particular topic, profiler 356 may augment the user profile of this user with an indication that this user has an interest in the particular topic. For patterns relating to search queries, knowledge gap analyzer 364 may analyze the search query patterns and identify potential knowledge gaps relating to certain topics in which useful information may be lacking in the knowledge corpus. Knowledge gap analyzer 364 may also identify potential content sources to fill the identified knowledge gaps. For example, a potential content source that may fill a knowledge gap can be a knowledge publisher who frequently publishes in a related topic, the Internet, or some other source from which information pertaining to the knowledge gap topic can be obtained.

Recommendations generator 366 may provide a knowledge mapping service that provides knowledge pack recommendations to knowledge consumers of knowledge automation system 300. Recommendations generator 366 may compare the user profile of a user with the available knowledge packs in knowledge bank 340, and based on the interests of the user, recommend knowledge packs to the user that may be relevant for the user. For example, when a new product is released and a product training knowledge pack is published for the new product, recommendations generator 366 may identify knowledge consumers who are part of a sales team, and recommend the product training knowledge pack to those users. In some embodiments, recommendations generator 366 may generate user signatures form the user profiles and knowledge signatures from the knowledge elements (e.g., knowledge units and/or knowledge packs), and make recommendations based on comparisons of the user signatures to the knowledge signatures. The analysis can be performed by recommendations generator 366, for example, when a new knowledge pack is published, when a new user is added, and/or when the user profile of a user changes.

### II. Thumbnail Image Generation

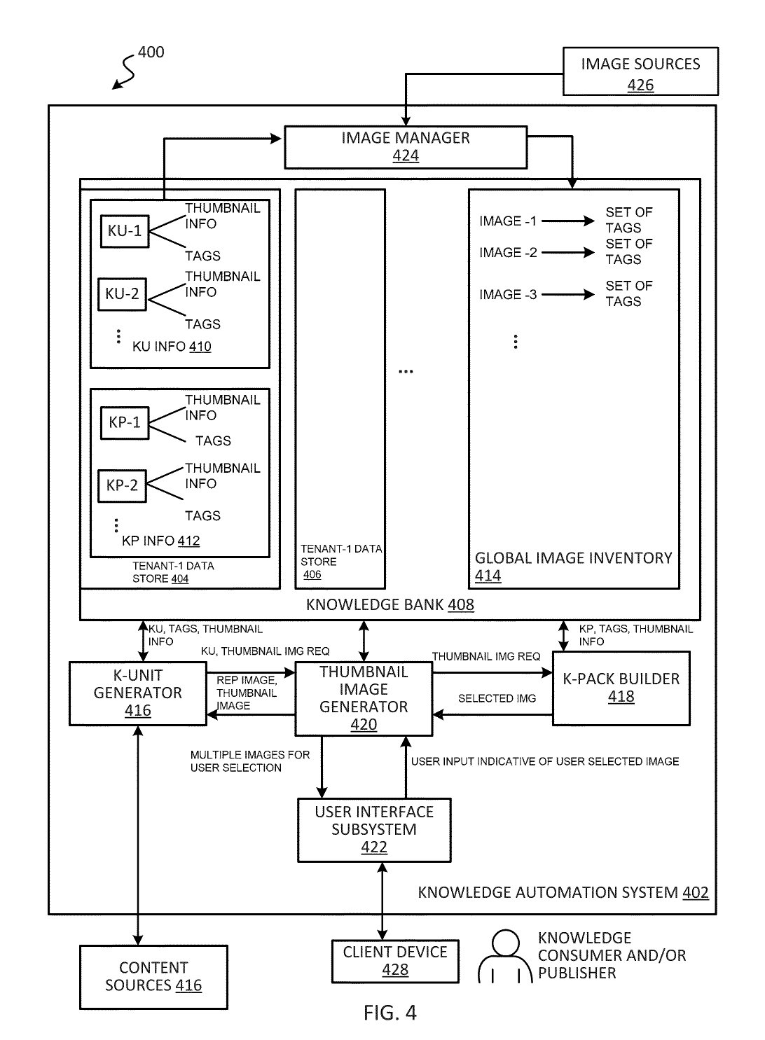

FIG. 4 illustrates a multi-tenant environment 400 in which a knowledge automation system 402 can be implemented, according to some embodiments. In an embodiment, knowledge automation system 402 may include tenant-specific data. The tenant-specific data comprises data for various subscribers or customers (tenants) of knowledge automation system 402. Data for one tenant is typically isolated from data for another tenant. For example, tenant 1's data is isolated from tenant 2's data. The data for a tenant may include, without restriction, subscription data for the tenant, data used as input for various services subscribed to by the tenant, data (e.g., knowledge units and knowledge packs) generated by knowledge automation system 402 for the tenant, customizations made for or by the tenant, configuration information for the tenant, and the like. Customizations made by one tenant can be isolated from the customizations made by another tenant. The tenant data may be stored in knowledge automation system 402 or may be in one or more data repositories accessible to knowledge automation system 402.

In an embodiment of the present invention, knowledge automation system 402 may be configured to store the tenant-specific data in separate data stores 404, 406 within a knowledge bank 408 of knowledge automation system 402. For instance, the knowledge units and knowledge packs associated with a first tenant (tenant-1) may be stored in a first data store 404, the knowledge units and knowledge packs associated with a second tenant (tenant-2) may be stored in a second data store 406 and so on. In an embodiment, the knowledge units (KU-1, KU-2 and so on) may be stored in a sub-data store 410 within a data store (e.g., 404 or 406) and the knowledge packs (KP-1, KP-2 and so on) may be stored in a sub-data store 412 within a data store (e.g., 404 or 406). In certain embodiments, and as will be discussed in detail below, the tenant-specific knowledge units and knowledge packs may be associated with one or more sets of tags and thumbnail information. As noted above, the sets of tags may represent key terms contained in the knowledge unit or knowledge pack (e.g., may include key words, key phrases, entities, dates, etc. and number of occurrences of such in the knowledge unit) and/or associated metadata (e.g., author, location such as URL or identifier of the content, date, language, subject, title, file or document type, etc.). Thumbnail information, discussed in greater detail below, is also associated with knowledge units and knowledge packs and may include a representative image for the knowledge unit or knowledge pack and its associated thumbnail image.

In an embodiment, knowledge automation system 402 may include a knowledge unit generator 416, a knowledge pack builder 418, a thumbnail image generator 420, a user interface subsystem 422, an image manager 424 and a knowledge bank 408. The components of knowledge automation system 402 shown in FIG. 4 are not intended to be limiting. For example, in other embodiments, knowledge automation system 402 may include different, more or fewer components. These components may be implemented in hardware, software or a combination thereof.

In certain embodiments, thumbnail image generator 420 may be configured to analyze the data contents of a knowledge unit and/or knowledge pack generated by knowledge unit generator 416 and/or stored in knowledge bank 408 and generate a “representative image” for the knowledge unit and/or knowledge pack. As noted above, a representative image may refer to a visual representation of the data contents within the knowledge unit and/or knowledge pack. Based on the generated representative image, in some embodiments, thumbnail image generator 420 may be configured to generate a “thumbnail image” for the knowledge unit and/or knowledge pack. In some instances, the “thumbnail image” may refer to a reduced size version of the representative image of the knowledge unit and/or knowledge pack.

In an embodiment, thumbnail image generator 420 may receive a request to determine a representative image for a knowledge unit (KU). For example, such a KU may be generated by knowledge unit generator 416 and/or stored in knowledge bank 408. Knowledge unit generator 416 may be the same or similar to knowledge unit generator 306 discussed in FIG. 3 and may utilize a process similar to the process discussed in FIG. 3 to generate knowledge units.

Upon receiving the request, thumbnail image generator 420 may analyze the contents of the KU to determine a representative image for the KU. In an embodiment, the analysis of the KU may involve identifying text and non-text portions (e.g., graphical content such as images, figures, graphs, tables, and the like) of the KU and characteristics of these identified portions. For instance, the analysis may involve searching the KU for keywords such as “graph”, “figure” or “Fig” to locate the position of such regions within the KU. For example, for a text portion in the KU, thumbnail image generator 420 may identify key terms or tags associated with the KU. For instance, a key term may be identified based upon the frequency of the occurrence of the term in the KU, or based upon where the terms occur in KU and the like.

In certain embodiments, thumbnail image generator 420 can look for terms typically associated with graphical content to identify non-text content (e.g., graphical content such as images, figures, graphs, tables, and the like) within a knowledge unit. For example, thumbnail image generator 420 can include various object detection modules configured to identify different objects in an image. For example, object detection modules may apply image analysis techniques such as edge detection, curve detection, face detection, etc., to identify non-text objects within a document.

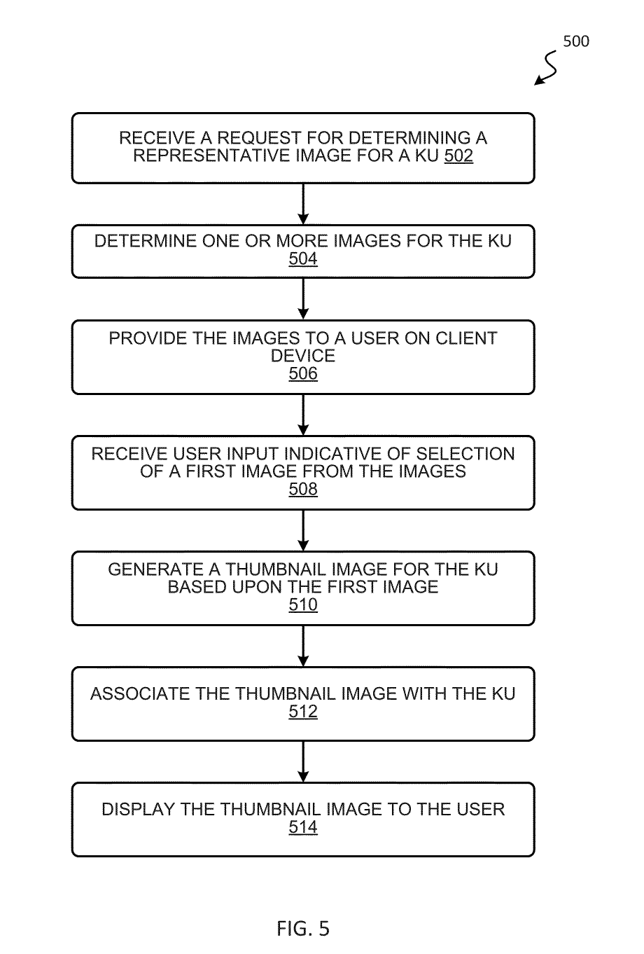

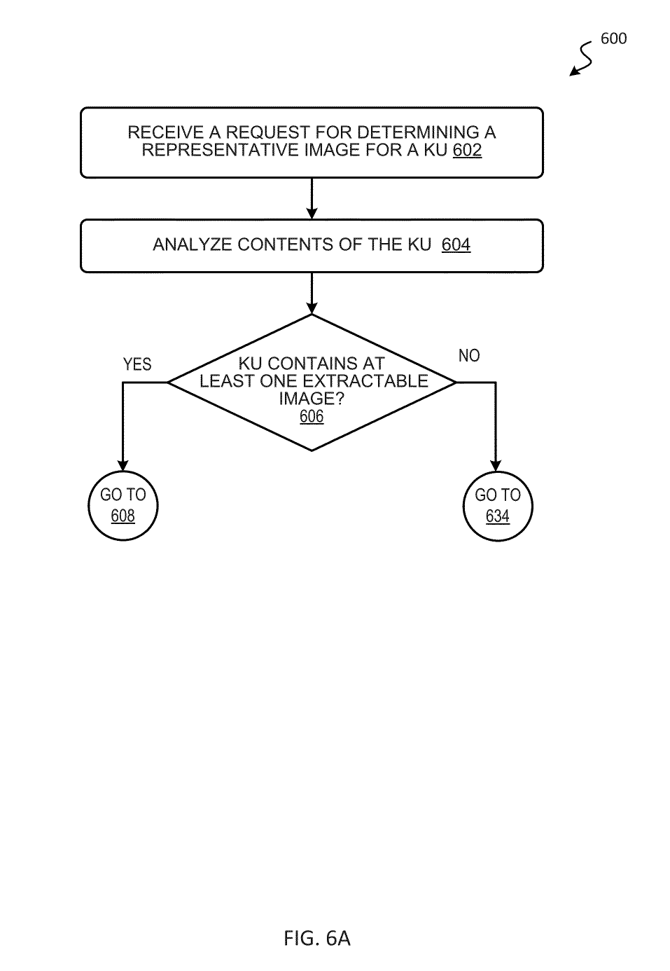

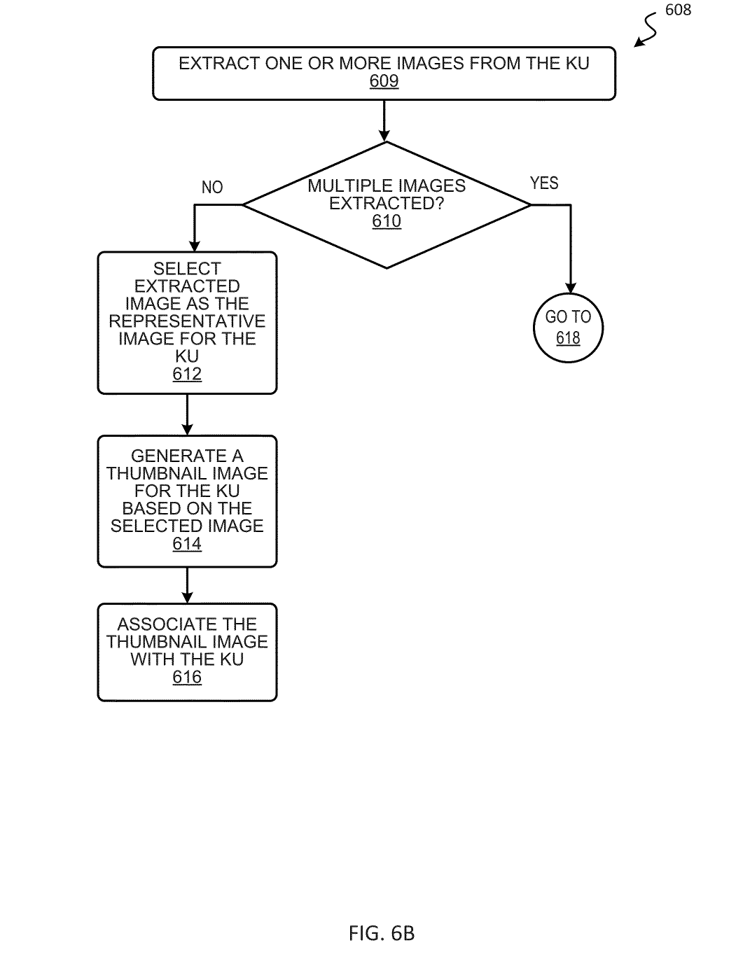

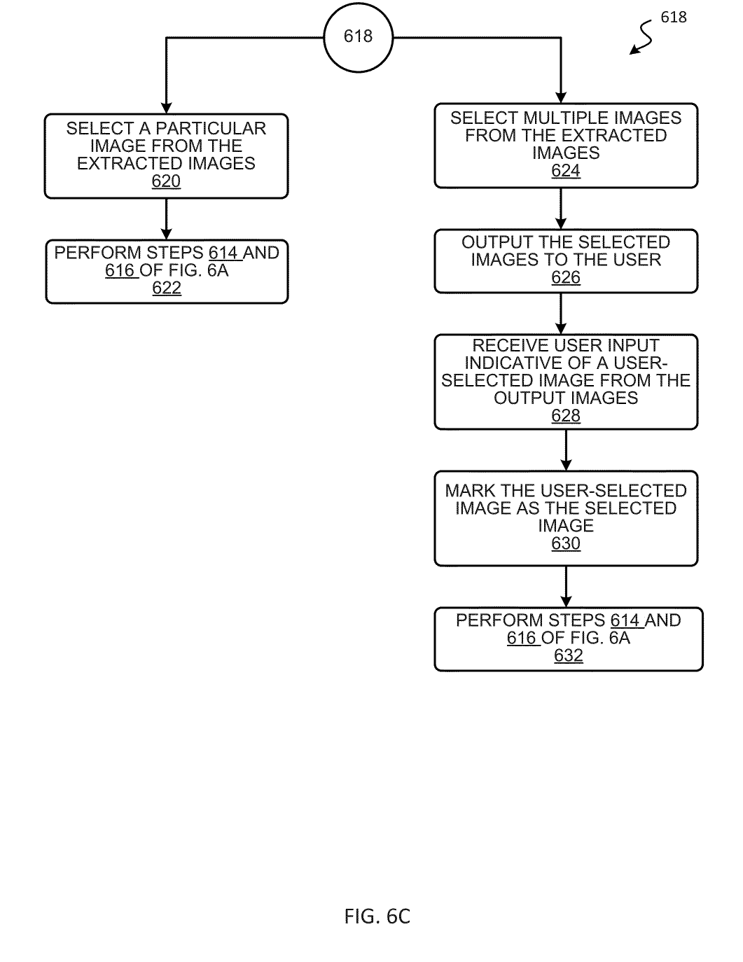

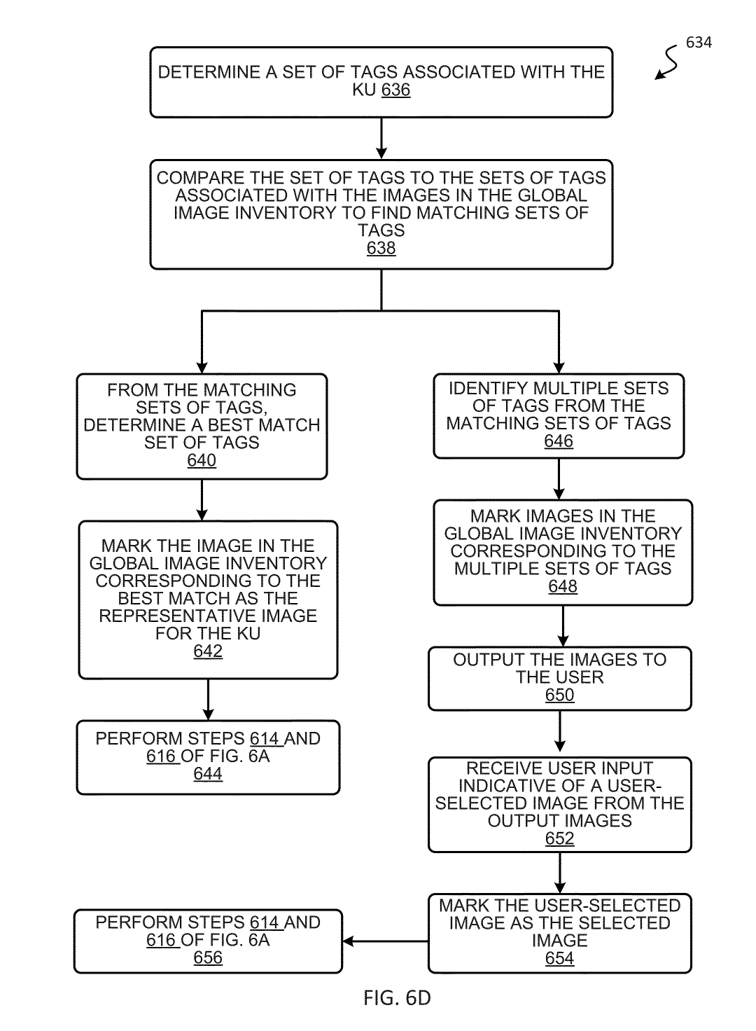

Thumbnail image generator 420 may then extract the identified non-text content to generate a set of one or more candidate representative images for the KU. In an embodiment, thumbnail image generator 420 may present the set of one or more candidate representative images to a user via a graphical user interface on client device 428 for selection by the user. For instance, when the user accesses knowledge automation system 402 using client device 428, user interface subsystem 422 may cause a graphical user interface to be displayed on client device 428 (e.g., via a browser application). Thumbnail image generator 420 may then receive user input indicative of a user selected representative image from the set of candidate images via the graphical user interface and generate a thumbnail image for the KU based on the user selected image. In alternate embodiments, thumbnail image generator 420 may also automatically select a particular representative image from the set of one or more candidate representative images and generate a thumbnail image for the KU based on the selected image. Additional details regarding the manner in which thumbnail image generator 420 may generate representative images and thumbnail images for a KU is discussed in detail in relation to FIG. 5 and FIGS. 6A-6D below.

In some embodiments, thumbnail image generator 420 may provide the representative image and the thumbnail image for the KU to knowledge unit generator 416. Knowledge unit generator may then associate thumbnail information with the KU and store the KU and thumbnail information associated with the KU in knowledge bank 408.

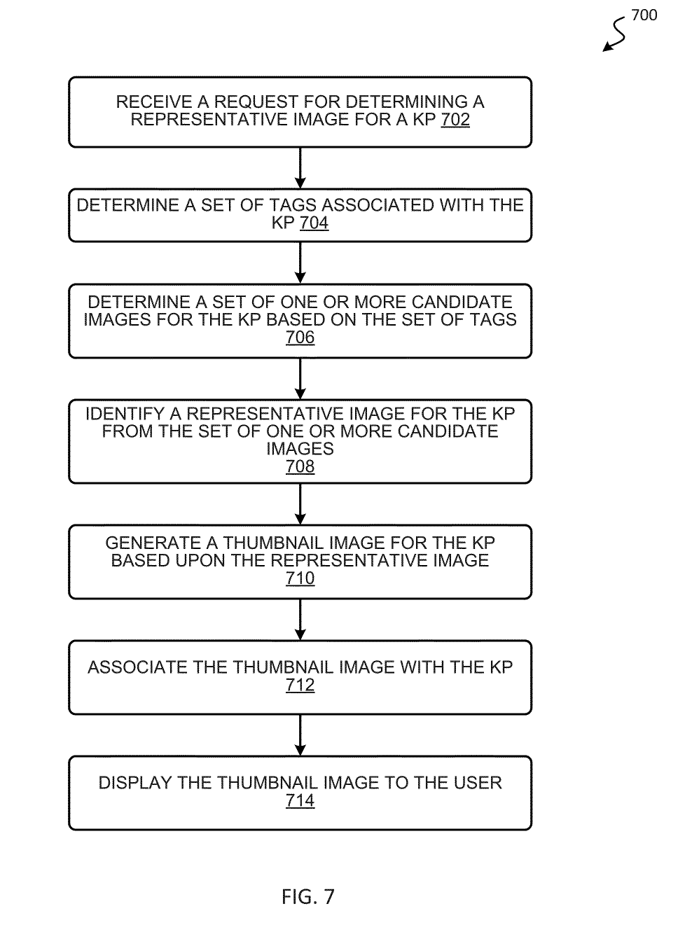

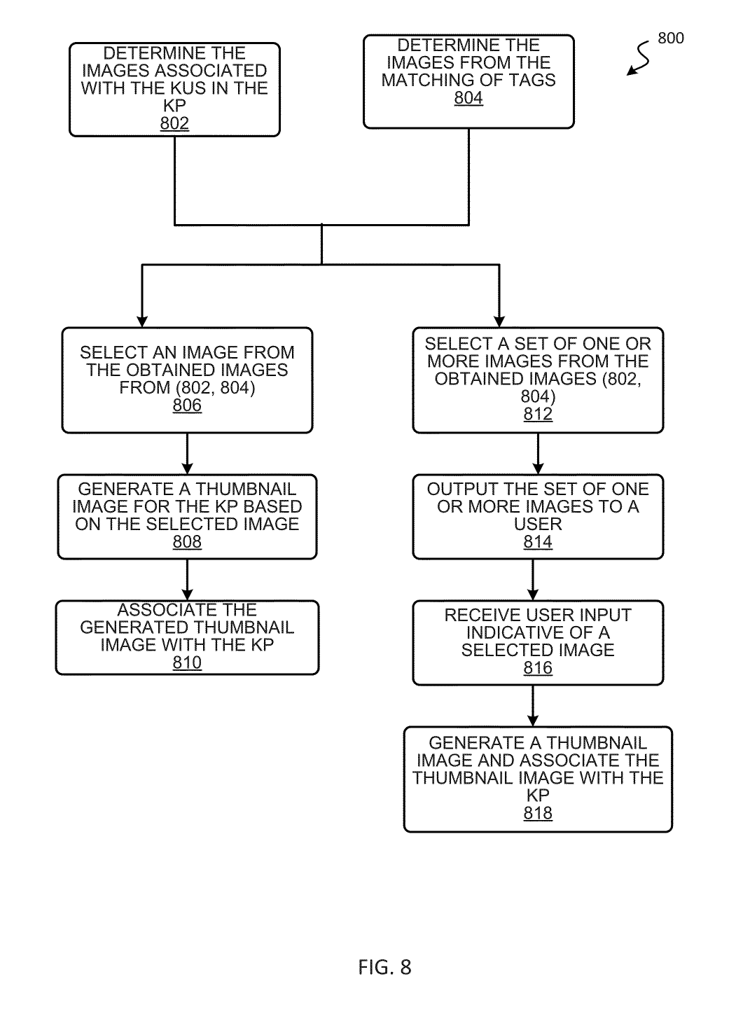

In certain embodiments, and as noted above, thumbnail image generator 420 may also generate thumbnail images for a knowledge pack. For instance, thumbnail image generator 420 may receive a request to determine a representative image for a knowledge pack (KP) built by knowledge pack builder 418 and/or stored in knowledge bank 408. Knowledge pack builder 418 may be the same or similar to knowledge pack builder 336 discussed in FIG. 3 and may utilize a process similar to the process discussed in FIG. 3 to build knowledge packs. In an embodiment, thumbnail image generator 420 may analyze tags associated with the knowledge units within the KP to determine a representative image for the KP. Thumbnail image generator 420 may then generate a thumbnail image for the KP based on the representative image. Additional details of the manner in which thumbnail image generator 420 may generate representative images and thumbnail images for a KP is discussed in detail in relation to FIGS. 7 and 8 below.

In certain embodiments, knowledge bank 408 may include a global image inventory 412. Global image inventory 414 may maintain and/or store an inventory of representative images for KUs and/or KPs from the different tenant data stores 404, 406. Global image inventory 424 may also store tag information (sets of tags) for each representative image for a KU and/or KP. In some embodiments, global image inventory 414 may also store images obtained from image sources 426. These image sources may include, for instance, images obtained from third party sources such as third-party images, graphics and content. In certain embodiments, and as will be discussed in detail below, thumbnail image generator 420 may utilize the image information stored in global image inventory 414 to generate a representative image and/or thumbnail image for a KU and/or KP.

In certain embodiments, image manager 424 in knowledge automation system 402 may populate global image inventory 412 with image information. For instance, image manager 424 may populate global image inventory 412 with representative images of KUs and/or KPs from tenant data stores 404, 406 and/or from third party images obtained from image sources 426. Additional details of the processes performed by knowledge automation system 402 to generate representative images and thumbnail images for KUs and/or KPs is discussed in FIGS. 5, 6A-6D, 7 and 8 below.

FIGS. 5, 6A-6D, 7 and 8 illustrate example flow diagrams showing respective processes 500, 600, 608, 618, 634, 700 and 800 of generating representative images and thumbnail images for a knowledge unit according to certain embodiments of the present invention. These processes are illustrated as logical flow diagrams, each operation of which that can be implemented in hardware, computer instructions, or a combination thereof. In the context of computer instructions, the operations may represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the process.

Additionally, some, any, or all of the processes may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program including a plurality of instructions executable by one or more processors. The computer-readable storage medium may be non-transitory. In some examples, the knowledge automation system (e.g., utilizing at knowledge unit generator 416, thumbnail image generator 420, knowledge pack builder 418, user interface subsystem 422, image manager 424 and knowledge bank 408) shown in at least FIG. 4 (and others) may perform the processes 500 and 600, 608, 618, 634, 700 and 800 of FIGS. 5, 6A-6D 7 and 8 respectively.

FIG. 5 illustrates a high level flow diagram of an example process 500 for generating representative images and/or thumbnail images for a knowledge unit, in accordance with an embodiment of the present invention. The process at 500 may begin at 502, when a request is received by thumbnail image generator 420 to determine a representative image for a knowledge unit (KU). For instance, thumbnail image generator 420 may receive a request from knowledge unit generator 416 to generate a representative image for a knowledge unit created by knowledge unit generator 416 and/or stored in knowledge bank 408. At 504, the process includes determining a set of one or more images for the KU. At 506, the process includes providing the set of one or more images to a user on a client device. In some embodiments, at 508, the process includes receiving user input indicative of a selection of a first image from the set of one or more images. In an example, the first image may be the representative image for the KU. At 510, the process includes generating a thumbnail image for the KU based upon the first image. At 512, the process includes associating the thumbnail image with the KU. In some embodiments, at 514, the process includes displaying the thumbnail image to the user via the user's client device. Additional details of the manner in which processes 502-514 of FIG. 5 may be performed is discussed in detail in relation to FIGS. 6A-6D.

In some embodiments, the user may select multiple images instead of a single image. In this embodiment, the process at 508 may include receiving a selection of the multiple (i.e., more than one) images and combining the selected one or more images into a single representative image for the knowledge pack. For instance, the process may include merging the selected one or more images onto a collage or animated image to generate a representative image for the knowledge unit.

FIG. 6A illustrates a flow diagram of an example process 600 for generating a thumbnail image for a knowledge unit in accordance with another embodiment of the present invention. The process at 600 may begin at 602 when a request is received by thumbnail image generator 420 to determine a representative image for a knowledge unit. Upon receiving the request, at 604, thumbnail image generator 420 analyzes the contents of the KU to determine a set of one or more images (e.g., candidate images) for the KU. As noted above, the analysis of the contents of a KU may involve identifying text and non-text portions (e.g., graphical content such as images, figures, graphs, tables, and the like) of the KU and characteristics of these identified portions to determine the images.

In some embodiments, the analysis of the data contents of the KU by thumbnail mage generator 420 may involve, extracting key terms from the KU from text regions and/or portions of the KU and converting each page of the KU into an image. The analysis may involve analyzing and separating the regions containing text and non-text regions. For each non-image region, the presence of lines, curves, and the like may checked to determine the presence of graphs in the region. Additionally, as noted above, a keyword search for “graph”, “figure” or “Fig” (that provide a good understating of the summary of the contents of the KU) can be performed to locate the position of such regions in the KU. In some embodiments, these locations may be identified as candidates of high interest to be ultimately used as thumbnail images for the KU.

In some embodiments, thumbnail mage generator 420 may analyze the text regions in the KU to identify terms which relate to the terms “graph” or “figure” to enhance the “graph” or “figure” by highlighting the related terms on it. In some examples, thumbnail mage generator 420 may execute object detection algorithms like face detection to localize regions for each non-image region. These localized regions may then be used as candidates for thumbnails. In some examples, thumbnail mage generator 420 may determine a class of object detectors to be used for the KU based on the category of the KU or based on keywords found in the textual region of the document.

In some embodiments, the analysis may involve analyzing the text regions to identify terms or phrases referring to the objects found by the object detector and adding the terms or phrases to the image of the object to enhance the image of the object. In some examples, a sliding window may be utilized for each such region and the window may be moved in the image. Additionally, image features such as color diversity, histogram, grey scale version of the region, text density and the like can be computed for a particular window position. In some examples, region growing scheme for the window may be used so that multiple windows may be combined (grown) into a larger window. The processing described above for text region may also be performed for color-based features in the KU.

In certain embodiments, the above features may be used to cluster the windows into groups based on text density and color diversity. Images within two groups may further be clustered and an image from each group may be selected as representative images for the KU. In some embodiments, thumbnail image generator 420 may automatically choose an image with the highest color, diversity, or highest texture variation or other similar feature as the default representative image.

In some embodiments, the analysis of the KU may involve extracting key terms from the KU and using the key terms as search keys and performing a search for images from external resources. In some examples, a crawler may be used to download some of the matching images and the downloaded images may be used as candidate images for the KU. In some embodiments, the key terms of the KU and the image selected by the user may be tagged and stored in knowledge bank 408.

Based on the analysis performed by thumbnail image generator 420 as discussed above, at 606, thumbnail image generator 420 determines if the KU contains at least one extractable image. If it is determined the KU contains at least one extractable image, then, in some embodiments, thumbnail image generator 420 performs the process 608 described in FIG. 6B below. If it is determined the KU does not contain any extractable images, then thumbnail image generator 420 performs the process 634 described in FIG. 6C below.

FIG. 6B illustrates a flow diagram of an example process 608 for generating a thumbnail image for a knowledge unit when the knowledge unit contains at least one extractable image. For instance, the process at 608 may be triggered when thumbnail image generator 420 determines that the KU contains at least one extractable image (at step 606 of FIG. 6A). At 609, thumbnail image generator 420 extracts one or more images from the KU. At 610, thumbnail image generator 420 determines if multiple (e.g., more than one) images were extracted from the KU. If it is determined that the KU contains multiple extractable images, then, in some embodiments, thumbnail image generator 420 performs the process 618 described in FIG. 6C below.

If it is determined that the KU contains a single extracted image, then, in some embodiments, at 612, thumbnail image generator 420 selects the extracted image as the representative image for the KU. At 614, thumbnail image generator 420 generates a thumbnail image for the KU based on the representative image. As noted above, a “thumbnail image” may refer to a reduced size version of the representative image of the KU. At 616, thumbnail image generator 420 associates the thumbnail image with the KU. In some embodiments, and as noted above, thumbnail image generator 420 may provide thumbnail information comprising the representative image and the thumbnail image to knowledge unit generator 416. Knowledge unit generator 416 may then store the thumbnail information for the KU in knowledge bank 408.

FIG. 6C illustrates a flow diagram of an example process 618 for generating a thumbnail image for a knowledge unit when the knowledge unit contains multiple extractable images. In response to determining that the KU contains multiple extractable images, in one embodiment, at 620, thumbnail image generator 420 may automatically select a particular image from the multiple extractable images. In an embodiment, the selection of a particular image may involve scoring each of the multiple extractable images. For instance, as noted above, thumbnail image generator 420 may score each image based on a variety of features such as image location, image fidelity and/or image resolution, image size, color diversity, texture variation or other image feature. In an embodiment, thumbnail image generator 420 may calculate a score for an image I1 as follows:

Image Score (I1)=aX1+bX2+cX3

wherein, a, b, c and so on are weights that are assigned to image features, X1, X2, X3 and so on. The weights assigned to each image feature may be pre-determined by thumbnail image generator 420 in some embodiments, or determined manually by a user, e.g., an administrator of knowledge automation system 402. Thumbnail image generator 420 may then select an image from the multiple extractable images having the highest image score. At 622, thumbnail image generator 420 may perform the processes 614 and 616 described in FIG. 6A to generate a thumbnail image for the KU based on the selected image and associate the thumbnail image with the KU.

In an alternate embodiment, in response to determining that the KU contains multiple extractable images (at 618), thumbnail image generator 420 may perform the processes described in steps 624-632. For instance, at 624, thumbnail image generator 420 may select multiple (e.g., more than one) images from the images extracted at 618. In an embodiment, the selection may be based on a score determined for the images as discussed above. For instance, if it is determined that the KU contains 10 extractable images at 618, thumbnail image generator 420 may select 4 images out of the 10 images based on their respective scores. At 626, thumbnail image generator 420 may output the selected images to a user for example via a graphical user interface on the user's client. At 628, thumbnail image generator 420 may receive user input indicative of a user-selected image from the output images. In some examples, at 630, thumbnail image generator 420 may mark the user-selected image as the selected image. At 632, thumbnail image generator 420 may perform the processes 614 and 616 described in FIG. 6A to generate a thumbnail image for the KU based on the selected image and associate the thumbnail image with the KU.

FIG. 6D illustrates a flow diagram of an example process 634 for generating a thumbnail image for a knowledge unit when the knowledge unit does not contain any extractable images. For instance, the process at 634 may be triggered when thumbnail image generator 420 determines that the KU contains no extractable image (at step 606 of FIG. 6A). At 636, thumbnail image generator 420 determines a set of tags associated with the KU. For instance, the set of tags associated with the KU may be determined by retrieving the set of tags associated with the KU from knowledge bank 408. At 638, thumbnail image generator 420 may compare the set of tags associated with the KU to the sets of tags associated with the set of one or more images stored in global image inventory 414 to find matching sets of tags. The matching sets of tags may be determined by identifying the images in global image inventory 414 that have at least one matching tag with the set of tags associated with the KU.

In some embodiments, at 640, thumbnail image generator 420 may determine a best match set of tags from the matching sets of tags. In an example, thumbnail image generator 420 may determine the best match set of tags for the KU by identifying a set of tags from the matching sets of tags having the maximum number of tags that match the tags associated with the KU. For example, consider that a KU is associated with the following set of tags:

KU={T1, T2, T3, T4}

where T1, T2, T3 and T3 represent different tags (terms) that identify the KU.

Further, consider that the matching sets of tags associated with the sets of images stored in the global image inventory determined by thumbnail image generator 420 are as follows:

I1={T1, T2, T5, T6}

I2={T1, T3, T7, T8}

I3={T1, T2, T3}

I4={T1, T2, T3, T7, T8}

In an embodiment, thumbnail image generator 420 may determine the best match set of tags from the matching sets of tags to be {T1, T2, T3} associated with image I3. This is because, I3 is associated with a maximum number of tags {T1, T2, T3} that match the tags {T1, T2, T3, T4} associated with the KU.

At 642, thumbnail image generator 420 may mark or identify the image in the global image inventory corresponding to the best match set of tags as the representative image for the KU. For instance, per the example discussed above, thumbnail image generator 420 may mark image I3 as the representative image for the KU. At 644, thumbnail image generator 420 may perform the processes 614 and 616 described in FIG. 6A to generate a thumbnail image for the KU based on the selected image and associate the thumbnail image with the KU.

In an alternate embodiment, at 646, instead of identifying a single best match set of tags as discussed above, thumbnail image generator 420 may identify multiple sets of tags from the matching sets of tags determined in 638 as best match sets of tags. For instance, as per the example discussed above, thumbnail image generator 420 may identify that the set of tags {T1, T2, T3} associated with image I3 and the set of tags {T1, T2, T3, T7, T8} associated with I4 to be best match sets of tags for the KU.

At 648, thumbnail image generator 420 may mark the images (e.g., I3, I4) in the global image inventory that correspond to the best match sets of tags. At 650, thumbnail image generator 420 may output the images to the user on the user's client device. At 652, thumbnail image generator 420 may receive user input indicative of a user-selected image from the output images. At 654, thumbnail image generator 420 may mark the user-selected image as the representative image for the KU. In some embodiments, at 656, thumbnail image generator 420 may then perform the processes 614 and 616 of FIG. 6A to generate a thumbnail image for the KU based on the representative image and associate the thumbnail image with the KU.

The above discussion related to the generation of a representative image and a thumbnail image for a knowledge unit (KU) generated by knowledge automation system 402. In an alternate embodiments, thumbnail image generator 420 may also generate representative images and thumbnail images for a knowledge pack (KP) built by knowledge automation system 402. These processes are discussed in FIGS. 7-8 below.

FIG. 7 illustrates a high level flow diagram of an example process 700 for generating a thumbnail image for a knowledge pack, in accordance with an embodiment of the present invention. The process at 700 may begin at 702, when a request is received by thumbnail image generator 420 to determine a representative image for a knowledge pack (KP). For instance, thumbnail image generator 420 may receive a request from knowledge pack builder 418 to generate a representative image for a knowledge pack built by knowledge pack builder 418 and/or stored in knowledge bank 408. At 704, thumbnail image generator 420 may determine a set of tags associated with the KP (for e.g., based on tag information for the KP stored in knowledge bank 408). For instance, the set of tags for a KP may include a union of the sets of tags of the individual KUs within the KP and the set of tags associated with the KP. At 706, thumbnail image generator 420 may determine a set of one or more images for the KP based on the set of tags. At 708, thumbnail image generator 420 may determine a representative image for the KP from the set of one or more images. At 710, thumbnail image generator 420 may generate a thumbnail image for the KP based on the representative image.

At 712, thumbnail image generator 420 may associate the thumbnail image with the KP. At 714, thumbnail image generator 420 may display the thumbnail image for the KP via the user's client device.

In some embodiments, the processes 704-710 performed by thumbnail image generator 420 to determine a set of one or more candidate images for the KP, identify a representative image for the KP and generate a thumbnail image for the KP respectively may be similar to the processes 636-656 described in FIG. 6D for a KU. For instance, based on the determined set of tags for the KP (in 704), thumbnail image generator 420 may compare the set of tags associated with the KP to the sets of tags associated with the images in the global inventory to find matching sets of tags for the KP. From the matching sets of tags, thumbnail image generator 420 may either determine a best match set of tags for the KP, in one embodiment or identify multiple sets of tags from the matching sets of tags, in another embodiment. If the thumbnail image generator 420 determines a best match set of tags, then thumbnail image generator 420 may mark the image in the global image inventory corresponding to the best match as the representative image for the KP. Then, thumbnail image generator 420 may generate a thumbnail image for the KP based on the representative image.

If, for example, thumbnail image generator 420 identifies multiple sets of tags from the matching sets of tags, then thumbnail image generator 420 may determine images in the global image inventory that correspond to the multiple sets of tags and output the images to a user. Then, thumbnail image generator 420 may receive user input indicative of a user-selected image from the output images, mark the user-selected image as a representative image for the KP and generate a thumbnail image for the KP.

The example illustrated in FIG. 7 described a process by which thumbnail image generator 420 generated a representative image and/or a thumbnail image for a KP based on identifying tags associated with the KP. In an alternate embodiment, and as described in FIG. 8, thumbnail image generator 420 may also utilize representative images associated with the KUs within a KP (e.g., from global image inventory 414) in addition to the tags associated with the KP to generate representative image and/or a thumbnail image for the KP.

FIG. 8 illustrates a high level flow diagram of an example process 800 for generating a thumbnail image for a knowledge pack (KP) in accordance with another embodiment of the present invention. The process at 800 may be triggered, for instance, when thumbnail image generator 420 receives a request to generate a representative image and/or a thumbnail image for a KP. At 802, thumbnail image generator 420 determines the representative images associated with the KUs within a KP (e.g., from global image inventory 414). At 804, thumbnail image generator 420 determines the images in the global image inventory that correspond to the multiple sets of tags for the KP obtained from the matching of tags as discussed in FIG. 7. Based on the obtained sets of images (from 802, 804), in one embodiment, thumbnail image generator 420 may perform the processing described in 806-810 to generate representative image and/or a thumbnail image for the KP. For instance, at 806, thumbnail image generator 420 may select an image from the obtained sets of images. At 808, thumbnail image generator 420 may generate a thumbnail image for the KP based on the selected (representative) image. At 810, thumbnail image generator 420 may associate the generated thumbnail image with the KP.

In an alternate embodiment, based on the obtained sets of images (from 802, 804), thumbnail image generator 420 may perform the processing described in 812-816 to representative image and/or a thumbnail image for the KP. For instance, at 812, thumbnail image generator 420 may select a set of one or more images from the obtained images. At 814, thumbnail image generator 420 may output the set of one or more images to a user for selection. At 816, thumbnail image generator 420 may receive user input indicative of a user-selected image. At 818, thumbnail image generator 420 may perform processes (e.g., 808, 810) discussed above to generate a thumbnail image for the KP based on the selected (representative) image and associate the generated thumbnail image with the KP.

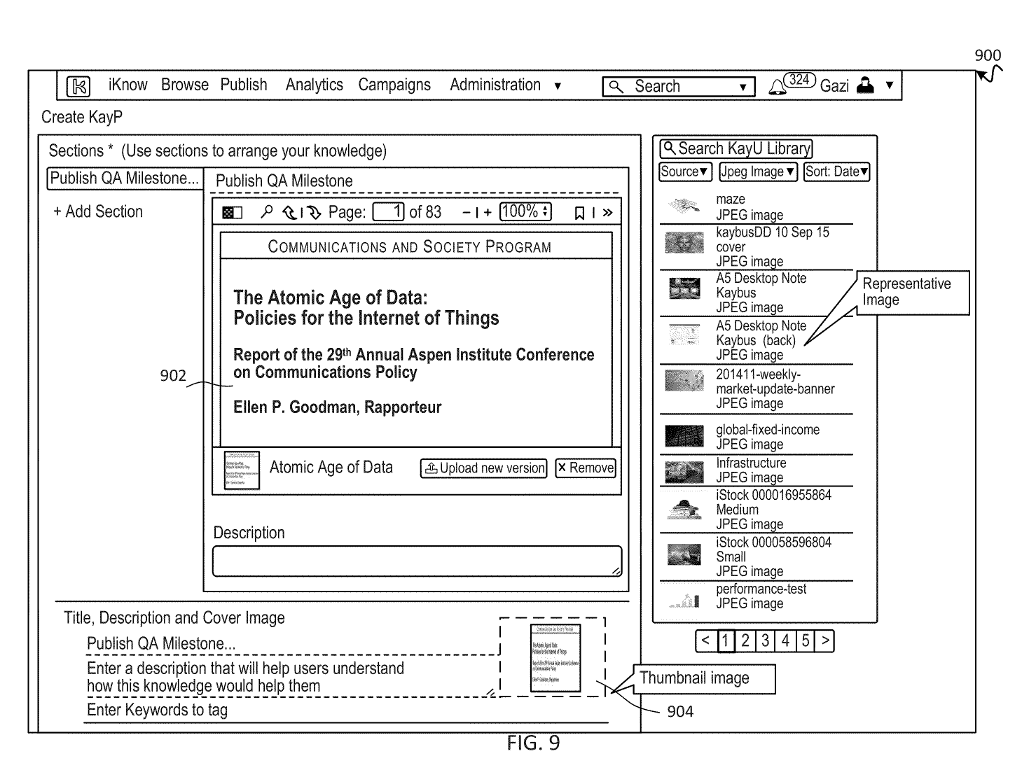

FIG. 9 illustrates a graphical user interface 900 for displaying representative images and thumbnail images for a knowledge unit and/or a knowledge pack, according to some embodiments. Graphical user interface 900 may include a knowledge unit and/or knowledge pack representation area 902 that displays a set of one or more images associated with a knowledge unit and/or knowledge pack. As noted above, in an embodiment, a user may select one or more of the images displayed in area 902 and the user-selected images may be received by knowledge automation system 402. Knowledge automation system may then generate a representative image for the knowledge unit and/or knowledge pack based on the user-selected images. The representative image for the knowledge unit and/or knowledge pack may be displayed in area 904 to the user. In some embodiments, knowledge automation system 402 may then generate a thumbnail image for the knowledge unit and/or knowledge pack based on the representative image. The thumbnail image may be displayed in area 906 to the user.

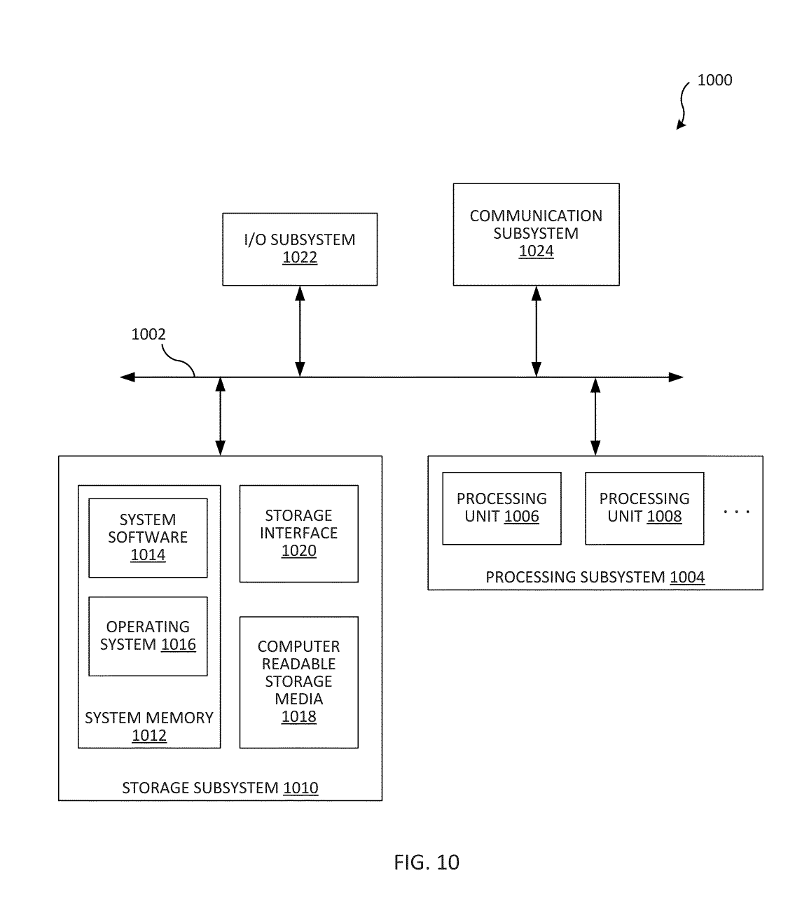

FIG. 10 depicts a block diagram of a computing system 1000, in accordance with some embodiments. Computing system 1000 can include a communications bus 1002 that connections one or more subsystems, including a processing subsystem 1004, storage subsystem 1010, I/O subsystem 1022, and communication subsystem 1024.

In some embodiments, processing subsystem 1008 can include one or more processing units 1006, 1008. Processing units 1006, 1008 can include one or more of a general purpose or specialized microprocessor, FPGA, DSP, or other processor. In some embodiments, processing unit 1006, 1008 can be a single core or multicore processor.

In some embodiments, storage subsystem can include system memory 1012 which can include various forms of non-transitory computer readable storage media, including volatile (e.g., RAM, DRAM, cache memory, etc.) and non-volatile (flash memory, ROM, EEPROM, etc.) memory. Memory may be physical or virtual. System memory 1012 can include system software 1014 (e.g., BIOS, firmware, various software applications, etc.) and operating system data 1016. In some embodiments, storage subsystem 1010 can include non-transitory computer readable storage media 1018 (e.g., hard disk drives, floppy disks, optical media, magnetic media, and other media). A storage interface 1020 can allow other subsystems within computing system 1000 and other computing systems to store and/or access data from storage subsystem 1010.

In some embodiments, I/O subsystem 1022 can interface with various input/output devices, including displays (such as monitors, televisions, and other devices operable to display data), keyboards, mice, voice recognition devices, biometric devices, printers, plotters, and other input/output devices. I/O subsystem can include a variety of interfaces for communicating with I/O devices, including wireless connections (e.g., Wi-Fi, Bluetooth, Zigbee, and other wireless communication technologies) and physical connections (e.g., USB, SCSI, VGA, SVGA, HDMI, DVI, serial, parallel, and other physical ports).

In some embodiments, communication subsystem 1024 can include various communication interfaces including wireless connections (e.g., Wi-Fi, Bluetooth, Zigbee, and other wireless communication technologies) and physical connections (e.g., USB, SCSI, VGA, SVGA, HDMI, DVI, serial, parallel, and other physical ports). The communication interfaces can enable computing system 1000 to communicate with other computing systems and devices over local area networks wide area networks, ad hoc networks, mesh networks, mobile data networks, the internet, and other communication networks.

In certain embodiments, the various processing performed by a knowledge modeling system as described above may be provided as a service under the Software as a Service (SaaS) model. According this model, the one or more services may be provided by a service provider system in response to service requests received by the service provider system from one or more user or client devices (service requestor devices). A service provider system can provide services to multiple service requestors who may be communicatively coupled with the service provider system via a communication network, such as the Internet.

In a SaaS model, the IT infrastructure needed for providing the services, including the hardware and software involved for providing the services and the associated updates/upgrades, is all provided and managed by the service provider system. As a result, a service requester does not have to worry about procuring or managing IT resources needed for provisioning of the services. This significantly increases the service requestor's access to these services in an expedient manner at a much lower cost point.

In a SaaS model, services are generally provided based upon a subscription model. In a subscription model, a user can subscribe to one or more services provided by the service provider system. The subscriber can then request and receive services provided by the service provider system under the subscription. Payments by the subscriber to providers of the service provider system are generally done based upon the amount or level of services used by the subscriber.

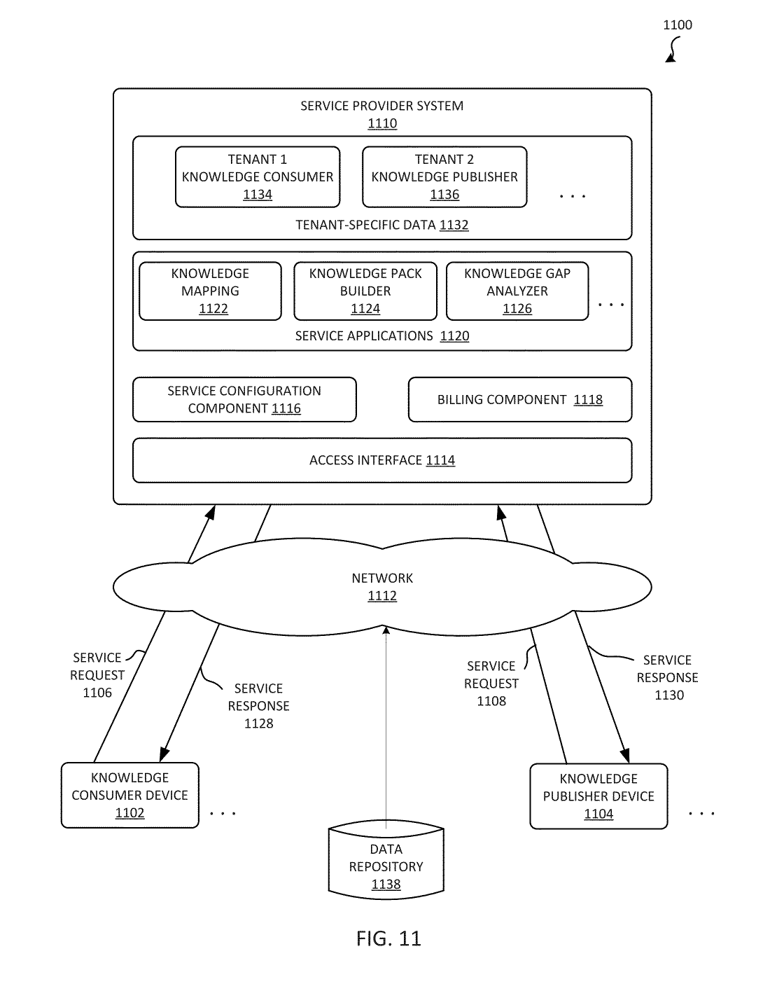

FIG. 11 depicts a simplified block diagram of a service provider system 1100, in accordance with some embodiments. In the embodiment depicted in FIG. 11, service requestor devices 1104 and 1104 (e.g., knowledge consumer device and/or knowledge publisher device) are communicatively coupled with service provider system 1110 via communication network 1112. In some embodiments, a service requestor device can send a service request to service provider system 1110 and, in response, receive a service provided by service provider system 1110. For example, service requestor device 1102 may send a request 1106 to service provider system 1110 requesting a service from potentially multiple services provided by service provider system 1110. In response, service provider system 1110 may send a response 1128 to service requestor device 1102 providing the requested service. Likewise, service requestor device 1104 may communicate a service request 1108 to service provider system 1110 and receive a response 1130 from service provider system 1110 providing the user of service requestor device 1104 access to the service. In some embodiments, SaaS services can be accessed by service requestor devices 1102, 1104 through a thin client or browser application executing on the service requestor devices. Service requests and responses 1128, 1130 can include HTTP/HTTPS responses that cause the thin client or browser application to render a user interface corresponding to the requested SaaS application. While two service requestor devices are shown in FIG. 11, this is not intended to be restrictive. In other embodiments, more or less than two service requestor devices can request services from service provider system 1110.

Network 1112 can include one or more networks or any mechanism that enables communications between service provider system 1110 and service requestor devices 1102, 1104. Examples of network 1112 include without restriction a local area network, a wide area network, a mobile data network, the Internet, or other network or combinations thereof. Wired or wireless communication links may be used to facilitate communications between the service requestor devices and service provider system 1110.

In the embodiment depicted in FIG. 11, service provider system 1110 includes an access interface 1114, a service configuration component 1116, a billing component 1118, various service applications 1120, and tenant-specific data 1132. In some embodiments, access interface component 1114 enables service requestor devices to request one or more services from service provider system 1110. For example, access interface component 1114 may comprise a set of webpages that a user of a service requestor device can access and use to request one or more services provided by service provider system 1110.

In some embodiments, service manager component 1116 is configured to manage provision of services to one or more service requesters. Service manager component 1116 may be configured to receive service requests received by service provider system 1110 via access interface 1114, manage resources for providing the services, and deliver the services to the requesting requesters. Service manager component 1116 may also be configured to receive requests to establish new service subscriptions with service requestors, terminate service subscriptions with service requestors, and/or update existing service subscriptions. For example, a service requestor device can request to change a subscription to one or more service applications 1122-1126, change the application or applications to which a user is subscribed, etc.).

Service provider system 1110 may use a subscription model for providing services to service requestors according to which a subscriber pays providers of the service provider system based upon the amount or level of services used by the subscriber. In some embodiments, billing component 1118 is responsible for managing the financial aspects related to the subscriptions. For example, billing component 1110, in association with other components of service provider system 1110, may be configured to determine amounts owed by subscribers, send billing statements to subscribers, process payments from subscribers, and the like.

In some embodiments, service applications 1120 can include various applications that provide various SaaS services. For example, one more applications 1120 can provide the various functionalities described above and provided by a knowledge modeling system.

In some embodiments, tenant-specific data 1132 comprises data for various subscribers or customers (tenants) of service provider system 1110. Data for one tenant is typically isolated from data for another tenant. For example, tenant 1's data 1134 is isolated from tenant 2's data 1136. The data for a tenant may include without restriction subscription data for the tenant, data used as input for various services subscribed to by the tenant, data generated by service provider system 1110 for the tenant, customizations made for or by the tenant, configuration information for the tenant, and the like. Customizations made by one tenant can be isolated from the customizations made by another tenant. The tenant data may be stored service provider system 1110 (e.g., 1134, 1136) or may be in one or more data repositories 1138 accessible to service provider system 1110.

It should be understood that the methods and processes described herein are exemplary in nature, and that the methods and processes in accordance with some embodiments may perform one or more of the steps in a different order than those described herein, include one or more additional steps not specially described, omit one or more steps, combine one or more steps into a single step, split up one or more steps into multiple steps, and/or any combination thereof.

It should also be understood that the components (e.g., functional blocks, modules, units, or other elements, etc.) of the devices, apparatuses, and systems described herein are exemplary in nature, and that the components in accordance with some embodiments may include one or more additional elements not specially described, omit one or more elements, combine one or more elements into a single element, split up one or more elements into multiple elements, and/or any combination thereof.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps. Various features and aspects of the above-described embodiments may be used individually or jointly.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter-process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific invention embodiments have been described, these are not intended to be limiting. Various modifications and equivalents are within the scope of the following claims. For example, one or more features from any embodiment may be combined with one or more features of any other embodiment without departing from the scope of the invention.

What is claimed is:

1. A method comprising:
receiving, by a data processing system, a request for determining a representative image for a knowledge unit;
determining a set of one or more images associated with the knowledge unit;
providing the set of one or more images to a user on a client device;
receiving user input indicative of a selection of a first image from the set of one or more images;
generating a thumbnail image for the knowledge unit based at least in part on the first image;
associating the thumbnail image with the knowledge unit; and
displaying the thumbnail image to the user via the client device.

2. The method of claim 1, wherein determining the set of one or more images for the knowledge unit comprises analyzing at least one of text regions and non-text regions in the knowledge unit.

3. The method of claim 1, further comprising displaying the knowledge unit associated with the thumbnail image to the user on the client device when the thumbnail image is displayed to the user.

4. The method of claim 1, wherein generating the thumbnail image for the knowledge unit further comprises:
identifying a plurality of features corresponding to the set of one or more images;
assigning a plurality of weights to the plurality of features;
determining a score for each image in the set of one or more images based on the plurality of weights;
identifying an image in the set of one or more images with the highest score;
determining the identified image as the representative image for the knowledge unit; and
generating the thumbnail image for the knowledge unit based at least in part on the representative image.

5. The method of claim 1, wherein generating the thumbnail image for the knowledge unit further comprises:
determining a set of tags associated with the knowledge unit, the set of tags identifying one or more terms that describe data content within the knowledge unit; and
generating the thumbnail image for the knowledge unit based at least in part on the set of tags.

6. The method of claim 5, wherein generating the thumbnail image for the knowledge unit further comprises:
identifying a stored set of one or more images;
comparing the set of tags associated with the knowledge unit to one or more sets of tags associated with the stored set of one or more images;
determining one or more matching sets of tags based on the comparing; and
determining a best match set of tags from the one or more matching sets of tags.

7. The method of claim 6, wherein generating the thumbnail image for the knowledge unit further comprises:
identifying an image from the stored set of one or more images that corresponds to the best match set of tags;
determining the identified image as the representative image for the knowledge unit; and
generating the thumbnail image for the knowledge unit based at least in part on the representative image.

8. The method of claim 6, wherein generating the thumbnail image for the knowledge unit further comprises:
identifying multiple sets of tags from the one or more matching sets of tags;
identifying images from the stored set of one or more images that correspond to each set of tags in the multiple sets of tags;
providing the identified images to a user on the client device;
receiving user input indicative of a user-selected image from the identified images;
identifying the user-selected image as the representative image for the knowledge unit; and
generating the thumbnail image for the knowledge unit based at least in part on the representative image.

9. The method of claim 1, further comprising generating a thumbnail image for a knowledge pack, wherein the knowledge pack comprises one or more knowledge units.

10. A system comprising:
one or more processors; and
a memory coupled with and readable by the one or more processors, the memory configured to store a set of instructions which, when executed by the one or more processors, causes the one or more processors to:
receive a request for determining a representative image for a knowledge pack;
determine a set of tags associated with the knowledge pack;
determine a set of one or more images for the knowledge pack based at least in part on the tags;
determine a representative image for the knowledge pack based on the set of one or more images;
generate a thumbnail image for the knowledge pack based at least in part on the representative image;
associate the thumbnail image with the knowledge pack; and
display the thumbnail image for the knowledge pack to a user via a client device.

11. The system of claim 10, wherein the one or more processors is further configured to determine the representative image for the knowledge pack based on identifying one or more representative images for one or more knowledge units within the knowledge pack.

12. The system of claim 10, wherein the one or more processors is further configured to:
provide the set of one or more images for the knowledge pack to the user;
receive user input indicative of a user-selected image from the set of one or more images; and
determine the representative image for the knowledge pack based at least in part on the user-selected image.

13. The system of claim 10, wherein the one or more processors is further configured to determine the set of tags associated with the knowledge unit as a union of the sets of tags of one or more knowledge units within the knowledge pack and the set of tags associated with the KP.

14. The system of claim 10, wherein the one or more processors is further configured to:
identify a stored set of one or more images;
compare the set of tags associated with the knowledge pack to one or more sets of tags associated with the stored set of one or more images;
determine one or more matching sets of tags based on the comparing; and
determine a best match set of tags from the one or more matching sets of tags.

15. The system of claim 14, wherein the one or more processors is further configured to:
identify an image from the stored set of one or more images that corresponds to the best match set of tags;
determine the identified image as the representative image for the knowledge pack; and
generate the thumbnail image for the knowledge pack based at least in part on the representative image.

16. The system of claim 10, wherein the one or more processors is further configured to display the knowledge pack associated with the thumbnail image to the user on the client device when the thumbnail image is displayed to the user.

17. A non-transitory computer-readable storage memory storing a plurality of instructions executable by one or more processors, the plurality of instructions comprising:
instructions that cause the one or more processors to receive a request for determining a representative image for a knowledge unit;
instructions that cause the one or more processors to determine a set of one or more images associated with the knowledge unit;
instructions that cause the one or more processors to provide the set of one or more images to a user on a client device;
instructions that cause the one or more processors to receive user input indicative of a selection of a first image from the set of one or more images;
instructions that cause the one or more processors to generate a thumbnail image for the knowledge unit based at least in part on the first image;
instructions that cause the one or more processors to associate the thumbnail image with the knowledge unit; and
instructions that cause the one or more processors to display the thumbnail image to the user via the client device.

18. The non-transitory computer-readable storage memory of claim 17, wherein instructions that cause the one or more processors to determine the set of one or more images comprises analyzing at least one of text regions and non-text regions in the knowledge unit.

19. The non-transitory computer-readable storage memory of claim 17, further comprising instructions that cause the one or more processors to:
receive user input indicative of a selection of a plurality of images from the set of one or more images;
combine the selected plurality of images to generate a representative image for the knowledge unit; and
generate a thumbnail image for the knowledge unit based at least in part on the representative image.

20. The non-transitory computer-readable storage memory of claim 17, wherein instructions that cause the one or more processors to generate the thumbnail image for the knowledge unit further comprises instructions to:
identify a plurality of features corresponding to the set of one or more images;
assign a plurality of weights to the plurality of features;
determine a score for each image in the set of one or more images based on the plurality of weights;
identify an image in the set of one or more images with the highest score;
determine the identified image as the representative image for the knowledge unit; and
generate the thumbnail image for the knowledge unit based at least in part on the representative image.
